(19) United States
(12) Patent Application Publication
(10) Pub. No.: US 2026/0221364 A1
(43) Pub. Date: Jul. 30, 2026

(54) ELECTROMAGNETIC REED SWITCH RELAY WITH SMALL CROSS CAPACITANCE

(71) Applicant: Pro-Tech Inlab, Limited Liability Company, Russian Federation, Moscow (RU)

(72) Inventor: Andrey Alekseevich PROVKIN, Moscow (RU)

(21) Appl. No.: 18/726,425

(22) PCT Filed: Jun. 15, 2023
(86) PCT No.: PCT/RU2023/000185

§ 371 Date: Jul. 3, 2024

(30) Foreign Application Priority Data
Jun. 8, 2023 (RU) 2023115139

(51) Int. Cl. H01H 51/28; H01H 1/66; H01H 50/10; H01H 50/16

(52) U.S. Cl. CPC H01H 51/282; H01H 1/66; H01H 50/10; H01H 50/163

(57) ABSTRACT

The invention relates to electrical engineering, in particular to devices for switching electrical circuits when exposed to a magnetic field on sealed contact groups (reed switches). An electromagnetic reed relay, characterized in that it contains a sealed bulb wherein two flexible contact cores are installed, at the outlet of which the first contact core is connected to the first terminal, and the second contact core is connected to the second terminal, and the second contact core comprises contact and non-contact parts with a gap in-between, and the first part of the second contact core is adjacent to the gap in the immediate vicinity of the sequential sites of its exit from the bulb and the site of connection of the second non-magnetic terminal, and the second part of the second contact core in the immediate vicinity of the gap with its other side is placed in a coil with a winding. The technical result is in reducing the transfer capacitance, quietness in operation and usability in wearable electronic devices.

### PRIOR ART OF THE INVENTION

The invention relates to electrical engineering, in particular to devices for switching electrical circuits when exposed to a magnetic field on sealed contact groups (reed switches).

### BACKGROUND OF THE INVENTION

The prior art (for example, RU123220U1, Dec. 20, 2012) discloses reed relays with normally open or closed contacts, with switching contacts, as well as with combinations thereof. The contacts are placed in a sealed bulb, which can be evacuated or filled with a gas to prevent oxidation of the contacts, or the contacts can be moistened with mercury to provide smooth relay activation. At least one pair of contacts is made of ferromagnetic materials. Under normal conditions, the contacts are held due to the forces of their own elasticity or a spring. The relay is controlled by a magnetic flux created by a magnetic field upon activation of an electric current in the winding, wherein the bulb (contact) is placed, or by an external field that creates a magnetic flux that is supplied to the contacts using a magnetic circuit. This creates an electromagnetic force that closes the contacts.

The use of existing types of reed relays in some pertinent arts is limited by high values of input-to-output transfer capacitance. For example, in the process of developing, testing and operating touch screen devices, technical means that simulate physical touches on the screen may be used. A conventional electromagnetic relay containing an armature in its design cannot be used as a switching element that transmits a control action from the user's body to the screen and leads to the registration of a touch event by the screen controller. Since it cannot provide reliable operation at the required switching frequency of 30-60 Hz and quietness. Moreover, known types of reed relays with normally open contacts also cannot be used. Since they do not provide the amount of electrical capacitance between the control circuit (relay winding or magnetic circuit) and the relay contact group (transfer capacitance), a critical characteristic that should not exceed 0.6 pF. In this case, the touch screen registers false positives or mistakenly identifies several separate touches as one permanent one.

### DISCLOSURE OF THE INVENTION

The technical problem is to create a reliable reed relay that provides a transfer capacitance value of not more than 0.6 pF, quietness and usability in wearable electronic devices.

The technical result is in reducing the transfer capacitance and usability in wearable electronic devices.

The technical result is attained owing to the electromagnetic reed relay containing a sealed bulb wherein two flexible contact cores are installed, at the outlet of which the first contact core is connected to the first terminal, and the second contact core is connected to the second terminal, and the second contact core comprises contact and non-contact parts with a gap in-between, and the first part of the second contact core is adjacent to the gap in the immediate vicinity of the sequential sites of its exit from the bulb and the site of connection of the second non-magnetic terminal, and the second part of the second contact core in the immediate vicinity of the gap with its other side is placed in a coil with a winding.

Besides, the part of the first contact core after its exit from the bulb and the site of attachment of the non-magnetic terminal and the non-contact part of the second contact core after its exit from the coil are counter-bent and located at the distance of the said gap, or are made straight.

Besides, it is supplemented with permanent magnets with axial magnetization installed in close vicinity to the cores.

Besides, the flexible contact cores are made of a ferromagnetic material with high magnetic conductivity.

Besides, the terminals are made of non-magnetic material.

Besides, the gap is an air gap or a plate of non-magnetic dielectric material installed in the gap in-between the core parts.

Besides, the gap width is determined based on:
g=ε0εTTR2/C,
where,
g is gap width;
ε0 is electric constant;
ε is relative permittivity of the medium in the gap;
R is radius of the reed switch core;
C is the capacitance between the ends of the core in the gap, which determines the transfer capacitance of the electromagnetic reed relay.

### BRIEF DESCRIPTION OF THE DRAWINGS

FIG. 1—E lectromagnetic reed relay with low transfer capacitance and a closed magnetic circuit of contact cores;

FIG. 2—D iagram of the passage of magnetic flux in a reed relay with low transfer capacitance and a closed magnetic circuit of contact cores;

FIG. 3—E lectromagnetic reed relay with low transfer capacitance and a closed magnetic circuit with magnetization of the contact cores;

FIG. 4—D iagram of the passage of magnetic flux in a reed relay with low transfer capacitance and a closed magnetic circuit with magnetization of the contact cores;

FIG. 5—E lectromagnetic reed relay with low transfer capacitance and open magnetic circuit with magnetization of the contact cores;

FIG. 6—D iagram of the passage of magnetic flux in a reed relay with low transfer capacitance and open magnetic circuit with magnetization of the contact cores;

FIG. 7—D iagram of the formation of the input and output capacitances of an electromagnetic reed relay with low transfer capacitance and a closed magnetic circuit of contact cores.

The following elements are indicated by numbers in the figures:
1—bulb;
2—contact core;
3—contact core;
4—non-magnetic terminal;
5—non-magnetic terminal;
6—contact core;
7—plate;
8—coil;
9—winding;
10—magnetic flux through the gap;
11—magnetic flux through the gap between the contact cores;
12—magnetic flux through the gap;
13—magnetic flux through the air;
14—permanent magnet;
15—permanent magnet;
16—magnetic flux of a permanent magnet;
17—magnetic flux of a permanent magnet;
18—magnetic flux through the air;
19—input parasitic capacitance formed by the winding turns and the contact core;
20—capacitance in the gap between the ends of the divided contact core (transfer);
21—capacitance in the gap between the ends of the undivided and divided contact cores (transfer);
22—capacitance formed by contact cores inside the bulb;
23—capacitance of the controlled electrical circuit (output).

The claimed electromagnetic reed relay contains, installed on the base, a sealed bulb wherein two flexible symmetrical normally open contact cores made of a ferromagnetic material with high magnetic inductivity are installed in parallel at a distance from each other. At one outlet from the bulb, the first contact core is connected to the first terminal, and at the other outlet from the bulb, the second contact core is connected to the second terminal, and the second contact core comprises contact and non-contact parts with a gap in-between, and the contact part of the second core is adjacent to the gap in the immediate vicinity of the sequential sites of its exit from the bulb and the site of connection of the second non-magnetic terminal, and the non-contact part of the second core in the immediate vicinity of the gap on its other side is placed in a coil with a control winding.

The gap provides galvanic isolation (absence of electrical contact) of the second core and the terminal of the switched circuit connected thereto, as well as the formation of a low electrical capacitance between the ends of the second core (formed in series between the control and controlled circuits of the relay and determining its transfer capacitance). The smaller the width of the gap, the smaller the losses when the magnetic flux passes through the gap and the smaller the current in the coil with the winding, but the greater is the transfer capacitance of the relay (it is anyway less than in a conventional relay).

Moreover, if necessary, a dielectric plate (calibration plate) can be placed in the gap. The dielectric plate can either be used only during the relay manufacturing process to form the gap and not be present in the finished product, or remain in the finished product. The plate facilitates the formation of a sufficiently small-sized gap in manufacture-it provides gap calibration (similar to using a feeler gauge when setting the spark plug gap in a car)-the ends of the core can simply be pressed against it and secured to the base. Next, it can be allowed to stay (also secured to the base). Or it can be part of production tooling and used in the manufacture of the next relay. In this case, there are no requirements limiting the choice of material it can be made of (non-magnetic dielectric).

The contact cores are made of a ferromagnetic material and perform the functions of electrical contacts and sections of magnetic circuits in the immediate vicinity of the reed switch bulb. The relay cores can be molded to form a closed magnetic circuit to reduce relay power consumption (reduce current in the control winding) with a similar gap. The relay cores can be magnetized with permanent magnets to reduce relay power consumption.

The continuing parts of the contact cores-one, after exiting the bulb and the site of attachment of the non-magnetic terminal, and the second non-contact part of the other, after exiting the coil, can be counter-bent and located at a distance not less than the established gap or can remain straight or have a different shape.

All relay components are housed in a base made of non-magnetic material, such as plastic. The base can be placed in the housing. In order to increase interference immunity, the design can be equipped with a magnetic shield. The magnetic shield can be made in the form of a casing made of a ferromagnetic material, covering the entire relay structure, or in the form of a plate/plates, or a different form, for targeted protection of the relay located between it and the source of the magnetic field, and to protect other devices from the influence of the relay-between them and the relay.

The technical result is attained by including a low capacitance formed between the ends of the second core located at a small distance relative to their area, in series between the control and controlled relay circuits (capacitances between the ends of the cores in the case of a closed magnetic circuit), with reduced influence of the capacitance control winding to the terminals of the controlled circuit due to its location on the core not electrically connected to the terminal of the controlled circuit. That is, we remove the influence of the winding on both terminals of the relay (normally, the winding is put on the bulb), but we are faced with its influence on the second terminal, which we remove with a gap.

Upon supply of a control current to the winding, a magnetic flux appears, passing through the gap in the divided contact core, the gap between the cores in the bulb and then closes around the winding, in particular along the cores. The resulting electromagnetic force connects both cores in the bulb, overcoming their elasticity, and closes the electrical circuit between them and the non-magnetic contacts. After turning off the current, the cores return to their original state. Therein, the electrical capacitance between the control winding and the reed switch (transfer) is reduced to the capacitance formed by the ends of the divided core (cores) in the gap and a low parasitic capacitance with the involvement of non-magnetic terminals and the reed switch. Considering the above, the value of the transfer capacitance between the input and output circuits of the relay does not exceed 0.6 pF.

FIG. 1 shows an example of the embodiment of the claimed relay. All components are assembled on a base (made of a non-magnetic material, such as plastic). Inside the sealed bulb (1) there are flexible contact cores (2) and (3) made of a ferromagnetic material with high magnetic inductivity. At the exit from the bulb (1), the first contact core (2) is connected to the first terminal (4), and the second contact core (3) is connected to the second terminal (5). Terminals (4) and (5) are made of non-magnetic material and are intended for connecting the switching (controlled) electrical circuit of the relay. The technology used to connect terminals (4) and (5) to contact cores (2) and (3) provides reliable electrical contact and does not compromise the seal of the bulb (1). The reed switch used in the relay disclosed herein differs from the standard one in that one of its contact cores comprise two parts: one part is a contact core (3), the second part is a non-contact core (6). A gap is formed between the core parts (3) and (6), into which a dielectric plate (7) can be placed.

The contact part of the second core (3) is adjacent to the gap in close vicinity to the sequential sites of its exit from the bulb (1) and the site of connection of the non-magnetic terminal (5). In the immediate vicinity of the gap, on the other side, the non-contact part of the core (6) is placed in a coil (8) with a winding (9). In all relay embodiments disclosed here, either a standard reed switch can be used after the operation of separating one contact core, or a tailor-made one-with one shortened contact core. The distance between the ends of parts (3) and (6) of the core, which also corresponds to the thickness of the plate (7), can be not more than 0.01 mm when using a reed switch with a 5 mm long bulb.

To calculate the gap width the following ratio can be used:
g=ε₀εTTR²/C,
where,
g is gap width (plate thickness);
ε0 is electric constant;
ε is relative permittivity of the medium in the gap (plate material or air);
R is radius of the reed switch core;
C is the capacitance between the ends of the core in the gap (0.1 pF), which determines the transfer capacitance of the electromagnetic reed relay.

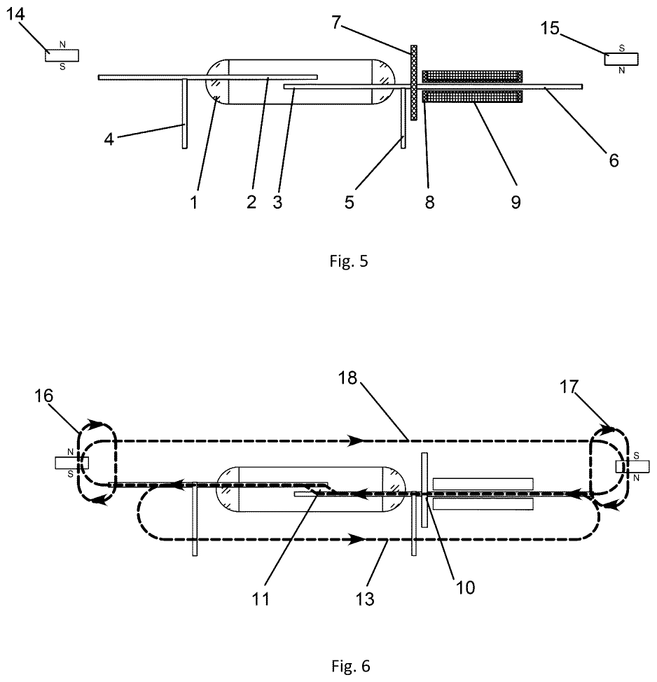

The part of the contact first core (2) after its exit from the bulb (1) and the site of attachment of the non-magnetic contact (4) and the non-contact part (6) of the second core after its exit from the coil (8) can be counter-bent and located at a gap distance, (air gap or gap formed by the plate (7) ), as shown in FIG. 1-4, 7, or can remain straight (FIGS. 5, 6) or have a different shape.

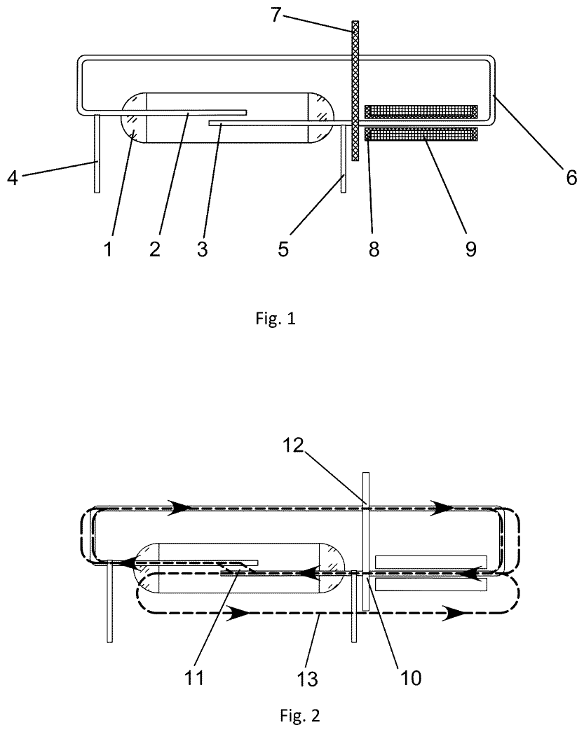

Upon supply of a control current to the winding (FIG. 1, item 9), a magnetic flux is created, as shown in FIG. 2 corresponding to the relay design according to FIG. 1, passing through the gap (FIG. 2, item 10), formed by the plate (FIG. 1, item 7), and through the gap (FIG. 2, item 11) between the contact cores (FIG. 1, items 2 and 3) and then it closes through the gap (FIG. 2, item 12), for example, with an inserted plate (FIG. 1, item 7). The other branch of the magnetic flux is closed through the air (FIG. 2, item 13). The electromagnetic force that is created in this case connects both contact cores (FIG. 1, items 2 and 3) in the bulb (FIG. 1, item 1), overcoming their elasticity, and closes the electrical circuit between the non-magnetic contact terminals (FIG. 1, item 4 and 5). After turning off the current, the contact cores (FIG. 1, items 2 and 3) return to their original state and open the switched electrical circuit.

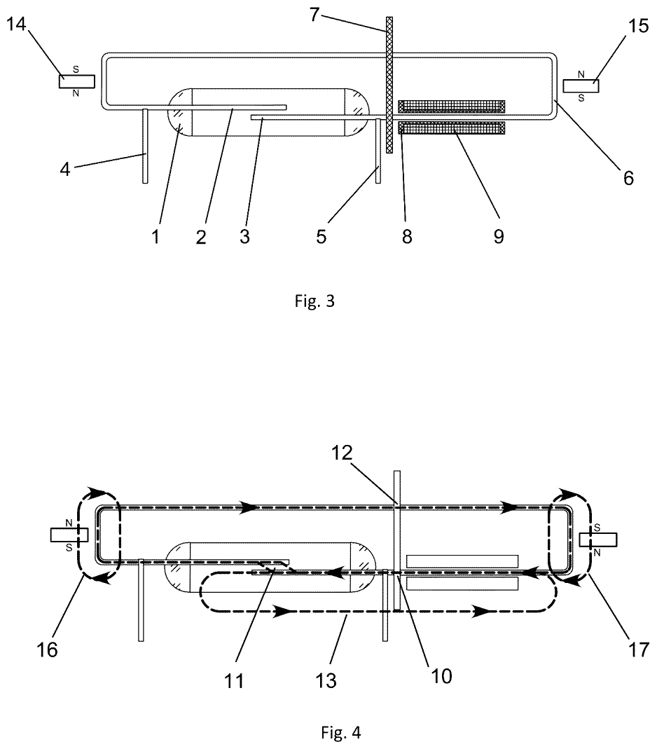

FIG. 3 shows another embodiment of the relay, which, unlike the example in FIG. 1, is supplemented with permanent magnets (14, 15) with axial magnetization. Moreover, the permanent magnet (14) magnetizes the contact core (2), and the permanent magnet (15) magnetizes the core (6). Magnets can be placed in close vicinity to the cores while maintaining the location of the magnetic fluxes indicated in the figures (they must add to the fluxes of the cores), depending on the characteristics and dimensions of the magnets. The closer the magnets are located, the less current can be in the coil with the control winding, but the lower the magnetic interference immunity of the relay, etc.

FIG. 4 shows the passage of magnetic flux for an embodiment of the relay according to FIG. 3. In general, the flux passage is similar to that shown in FIG. 2 except that the magnetic flux (FIG. 4, item 16) generated by the permanent magnet (FIG. 3, item 14) is added to the flux through the contact core (FIG. 3, item 2), and the magnetic flux (FIG. 3, item 17) formed by a permanent magnet (FIG. 3, item 15), is added to the flux through the core (FIG. 3, item 6). This solution enables to reduce the amount of current in the winding (FIG. 1, item 9) necessary to close the switched electrical circuit.

FIG. 5 shows an embodiment of the relay, wherein, unlike the above, the contact cores remain straight. This design is similar to that shown in FIG. 3. except for the absence of a gap between the ends of the cores (FIG. 3, item 2 and item 6).

FIG. 6 shows the passage of magnetic flux for the embodiment according to FIG. 5. In general, the flux passage is similar to that shown in FIG. 4 except for the passage of part of the flux through air (18). This design enables to further reduce the dimensions of the relay disclosed herein. All embodiments of the relay shown above (FIG. 1, FIG. 3, FIG. 5) in order to increase the interference immunity can be equipped with magnetic shields to reduce the influence of external magnetic fields, as well as reduce the influence of magnetic fields of the elements included in the relay: windings and permanent magnets to other devices.

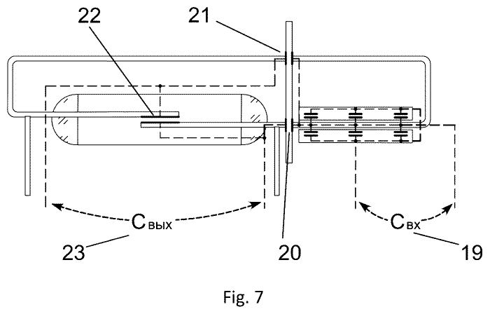

FIG. 7 shows the formation of the input and output capacitances of the embodiments of the relay disclosed herein. In accordance with the design shown in FIG. 1, FIG. 3, and FIG. 5 input parasitic capacitance (FIG. 7, item 19) is formed between the turns of the winding (FIG. 1, FIG. 3, FIG. 5, item 9) and the surface of the core (FIG. 1, FIG. 3, FIG. 5, item 6). The output capacitance (FIG. 7, item 23) is formed mainly between the contact cores inside the bulb (FIG. 1, FIG. 3, FIG. 5, item 1). In a conventional reed relay, the output of the switched circuit is electrically connected to the contact cores and the capacitance between the contact cores itself is added to the parasitic capacitance between the winding and the cores. Since the width of the winding occupies a significant length, the input parasitic capacitance has a large influence on the total output capacitance of the relay. In the embodiments of the relay disclosed herein, the input parasitic capacitance formed by the winding is added in series with the capacitance(s) between the ends of the cores at a gap distance. This enables to significantly reduce the value of the relay transfer capacitance. For example, with a diameter of contact cores of 0.4 mm, and a distance between their ends in the air gap of 0.01 mm, the capacitance is 0.1 pF. Reducing the gap can enable to reduce the current in the control winding even without the use of magnets, and with an increase in the diameter of the reed switch core, the gap can be increased to a value not exceeding 0.1 pF. In the embodiment according to FIG. 1 and FIG. 3, the transfer capacitance can be twice higher, i.e. not exceeding 0.2 pF. A reed switch with a 5 mm bulb length and a contact core diameter of 0.4 mm is characterized by capacitance values between flat symmetrical contact cores from 0.2 pF to 0.4 pF due to technological variation.

The design of the relay can also maintain the quietness of operation. Quietness can be achieved by using a reed switch with a relatively small bulb and lightweight contact cores, and/or by additionally enclosing the structure in sound-insulating material.

Besides, this relay design enables its use in wearable electronic devices. The core has a thickness less than the bulb. Therefore, the diameter of the coil of the claimed relay is smaller than the coil placed on the bulb in a conventional relay. The bulb and the coil with winding are located in the same plane. Thus, the height of the claimed relay is determined mainly by the thickness of the bulb used. For example, the bulb can be 2 mm in diameter, and the magnetic screens can be 1 mm in diameter, which allows to achieve fairly miniature relay sizes.

The use of such reed switches in all embodiments of the relay disclosed herein allows not to exceed the output capacitance value of more than 0.6 pF, which is significantly lower than the existing state of the art, and has successfully proven itself when switching signals affecting touch screens. A conventional reed relay with a similar reed switch is characterized by a capacitance value between the winding and contact cores exceeding 0.6 pF and cannot be used in this case. Besides, the embodiments of the relay disclosed herein increase interference immunity during operation, since the influence of the control circuit connected to the relay winding on the output signal is minimized, as well as provide the usability in wearable electronic devices, as the height of the relay does not exceed 3 mm.

1. An electromagnetic reed relay, characterized in that it contains a sealed bulb wherein two flexible contact cores are installed, at the outlet of which the first contact core is connected to the first terminal, and the second contact core is connected to the second terminal, and the second contact core comprises contact and non-contact parts with a gap in-between, and the first part of the second contact core is adjacent to the gap in the immediate vicinity of the sequential sites of its exit from the bulb and the site of connection of the second non-magnetic terminal, and the second part of the second contact core in the immediate vicinity of the gap with its other side is placed in a coil with a winding.

2. The electromagnetic reed relay according to claim 1, characterized in that a part of the contact first core after its exit from the bulb and the site of attachment of the non-magnetic terminal and the second non-contact part of the second core after its exit from the coil are counter-bent and located at the distance of the said gap, or are made straight.

3. The electromagnetic reed relay according to claim 1, characterized in that it is supplemented with permanent magnets with axial magnetization installed in close vicinity to the cores.

4. The electromagnetic reed relay according to claim 1, characterized in that terminals are made of a non-magnetic material.

5. The electromagnetic reed relay according to claim 1, characterized in that the gap is an air gap or a plate of a non-magnetic dielectric material installed in the gap in-between the core parts.

6. The electromagnetic reed relay according to claim 1, characterized in that the width of the gap is determined based on:
g=ε₀εTTR²/C,
where
g is gap width;
ε0 is electric constant;
ε is relative permittivity of the medium in the gap;
R is radius of the reed switch core;
C is the capacitance between the ends of the core in the gap, which determines the transfer capacitance of the electromagnetic reed relay.

7. The electromagnetic reed relay according to claim 1, characterized in that it additionally contains a magnetic shield made in the form of a casing made of a ferromagnetic material, covering the entire relay structure, or in the form of a plate located between the relay and the source of the magnetic field.
